(19) United States
(12) Patent Application Publication
(10) Pub. No.: US 2026/0216869 A1
(43) Pub. Date: Jul. 30, 2026

(54) PROPOSAL METHOD, PROPOSAL DEVICE, AND PROPOSAL PROGRAM

(71) Applicant: SONY GROUP CORPORATION, TOKYO (JP)

(72) Inventor: KOTOKO YAMAGUCHI, TOKYO (JP)

(21) Appl. No.: 19/149,558

(22) PCT Filed: Jan. 23, 2024
(86) PCT No.: PCT/JP2024/001732

§ 371 Date: Jul. 21, 2025

(30) Foreign Application Priority Data
Feb. 1, 2023 (JP) 2023-013807

(51) Int. Cl. B25J 9/16

(52) U.S. Cl. CPC B25J 9/1653; B25J 9/1671; B25J 9/1674

(57) ABSTRACT

A proposal method according to an aspect of the present disclosure includes causing a control unit to execute: a reception procedure for receiving a scenario for controlling behavior of a device, the scenario being commonly used among different devices; a determination procedure for determining whether or not a function or a mechanism mounted on a device equipped with the control unit satisfies requirements for executing the received scenario; and a proposal procedure for proposing an alternative means for executing the scenario when it is determined that it is difficult to execute the scenario.

### FIELD

The present disclosure relates to a proposal method, a proposal device, and a proposal program related to robot control.

### BACKGROUND

With the development of information processing technology, robots capable of performing various behaviors in response to arbitrary commands have become widespread. A user can make a robot perform an operation desired by the user by incorporating into the robot a control program (hereinafter referred to as a “scenario”) that sets in advance how the robot behaves under what conditions. For example, the user can arbitrarily create a scenario by using a program for creating a scenario called a scenario editor.

As technology related to a scenario, for example, technology for reducing the number of man-hours needed for creating a scenario by creating a scenario based on an instruction input by an operator has been proposed.

### CITATION LIST

### Patent Literature

Patent Literature 1: JP 2020-146784 A

### SUMMARY

### Technical Problem

According to the conventional technology, since the number of man-hours needed for creating a scenario is reduced, the burden on the user is reduced.

However, even if a user creates a scenario, the user may not be able to sufficiently make use of the scenario. For example, in a case where a robot with a camera for observing a certain object or a guide robot for guiding a customer is made to travel, the user often prepares an attention point, a travel route, and the like in advance as a scenario in order to make the robot perform a predetermined motion. In general, a scenario can operate even in different robots as long as the robots have the same platform (hereinafter referred to as “robotics PF”) serving as a control basic function for reading the scenario.

However, even in robots equipped with the same robotics PF, some robots may not be able to execute a scenario due to lack of a function necessary for executing the scenario because of a difference in a mounted sensor and operation mechanism, or due to a sensor malfunction. For this reason, some scenario can be executed only in a certain robot, and thus the user is required to create a scenario for each robot.

As described above, since robots differ largely from one robot to another in function and situation, it is difficult to use a scenario for operating robots in a general-purpose manner, and therefore there is a problem of lack of convenience.

Against this background, the present disclosure proposes a proposal method, a proposal device, and a proposal program capable of enhancing user's convenience regarding robot control.

### Solution to Problem

In order to solve the above problems, a proposal method according to an aspect of the present disclosure includes causing a control unit to execute a reception procedure for receiving a scenario for controlling behavior of a device, the scenario being commonly used among different devices, a determination procedure for determining whether or not a function or a mechanism mounted on a device equipped with the control unit satisfies requirements for executing the received scenario, and a proposal procedure for proposing an alternative means for executing the scenario when it is determined that it is difficult to execute the scenario.

### BRIEF DESCRIPTION OF DRAWINGS

FIG. 1 is a diagram illustrating an outline of proposal processing according to an embodiment.

FIG. 2 is a flowchart illustrating an example of a procedure of the proposal processing according to the embodiment.

FIG. 3 is a diagram (1) illustrating the proposal processing according to the embodiment.

FIG. 4 is a diagram (2) illustrating the proposal processing according to the embodiment.

FIG. 5 is a diagram (3) illustrating the proposal processing according to the embodiment.

FIG. 6 is a diagram illustrating an example of a data table related to the proposal processing.

FIG. 7 is a diagram illustrating an example of a user interface in scenario determination processing according to the embodiment.

FIG. 8 is a diagram illustrating an example of the user interface in the scenario execution processing according to the embodiment.

FIG. 9 is a diagram illustrating a configuration example of a robot according to the embodiment.

FIG. 10 is a diagram illustrating an outline of proposal processing according to a modified example.

FIG. 11 is a hardware configuration diagram illustrating an example of a computer that implements functions of a proposal device according to the present disclosure.

### DESCRIPTION OF EMBODIMENTS

Hereinafter, an embodiment will be described in detail with reference to the drawings. Note that, in the following embodiment, the same parts are denoted by the same reference signs to omit redundant description.

The present disclosure will be described according to the following order of items.
1. Embodiment
1-1. Outline of Proposal Processing According to Embodiment
1-2. Procedure of Proposal Processing According to Embodiment
1-3. Specific Example of Proposal Processing According to Embodiment
1-4. Example of User Interface of Proposal Processing
1-5. Configuration Example of Robot According to Embodiment
1-6. Modified Example
1-6-1. Device Configuration
1-6-2. Mode of Proposal Device
1-6-3. Mode of Proposal Processing
2. Other Embodiments
3. Effects of Proposal Method According to Present Disclosure
4. Hardware Configuration

### 1. Embodiment

### 1-1. Outline of Proposal Processing According to Embodiment

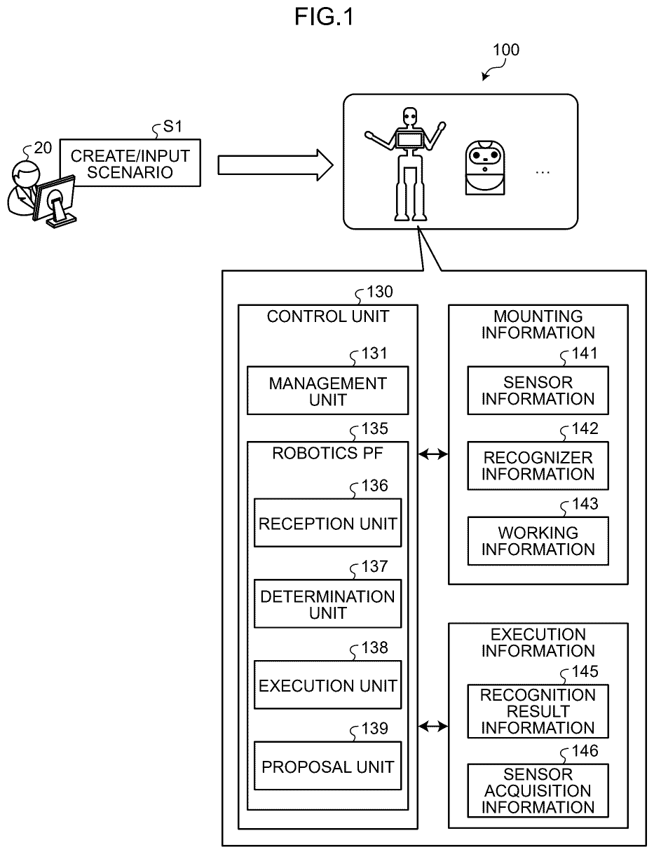

FIG. 1 is a diagram illustrating an outline of proposal processing according to the embodiment. The proposal processing according to the embodiment is implemented by a robot 100 and a user 20 illustrated in FIG. 1.

The robot 100 is an example of a proposal device that executes the proposal processing according to the embodiment. Regardless of the type such as an autonomous travel type or an installation type, the robot 100 may have any form as long as it has a function as an autonomous information device capable of reading a scenario and executing a behavior according to the scenario.

The user 20 is a person who creates a scenario for operating the robot 100, and is, for example, an administrator or an operator of the robot. Note that, in the present disclosure, the user 20 may mean an information processing terminal operated by the user 20. For example, in order to give a desired behavior to the robot 100, the user 20 creates a scenario using a dedicated application (scenario editor) or the like, and transmits the created scenario to the robot.

With technological development of robots such as voice interaction and image recognition, the user 20 can create a scenario by combining simple commands and conditions. Specifically, the user 20 creates a scenario incorporating a desired operation by combining an action such as “wait for a person to approach to a certain distance”, an action such as “greet a person when the person approaches to a certain distance”, and the like.

However, if the robot 100 is not equipped with an image sensor for image recognition or the image sensor is broken when the user 20 creates the above scenario, the robot cannot recognize that a person has approached and thus cannot execute the scenario. In this case, the robot can execute the scenario if the user 20 creates a scenario for each of sensors included in respective robots or sets an operation in the event of a malfunction, but this increases the user 20's labor. This is because, in general, a scenario prepared by the user 20 is often static information, and therefore it is difficult to replace it with a scenario created according to a sensor of the robot or a function (recognizer) of operating the sensor. That is, in the robot control, there is a challenge of operating a scenario in a general-purpose manner regardless of which robot is used and enhancing the convenience of the user 20 regarding the control.

Therefore, the robot 100 which is an example of the proposal device according to the present disclosure solves the above problem by the proposal processing to be described below. Specifically, the robot 100 acquires a scenario commonly used among different robots, and determines whether or not the function mounted on the robot 100 satisfies requirements for executing the acquired scenario. Then, if determining that it is difficult to execute the scenario, the robot 100 proposes an alternative means for executing the scenario. Besides proposing the alternative means, the robot 100 may also automatically update the scenario based on the proposed alternative means.

For example, in a case where the scenario includes a branch using image recognition (for example, human pose estimation) and the robot 100 does not have a human recognition function, the robot 100 proposes a branch by a voice recognition function as an alternative means or proposes acquisition of a human recognition function via a network as an alternative means. As a result, the robot 100 can execute the scenario regardless of which robot is used as long as such robots commonly have the basic function (the same robotics PF) for enabling reading of the created scenario. As a result, the robot 100 can enhance the convenience of the user 20 regarding robot control.

Hereinafter, an outline of the proposal processing according to the embodiment will be described with reference to FIG. 1. In the example of FIG. 1, it is assumed that the user 20 creates a general-purpose scenario and transmits the created scenario to the robot 100 via a network or the like.

The robot 100 according to the embodiment has a functional configuration illustrated in FIG. 1 and executes the scenario acquired from the user 20.

A control unit 130 is a configuration for causing the robot 100 to function as an information processing apparatus, and is, for example, a central processing unit (CPU), a micro processing unit (MPU), a GPU, or the like. The control unit 130 includes a management unit 131 and a robotics PF 135. In addition, the robotics PF 135 includes a reception unit 136, a determination unit 137, an execution unit 138, and a proposal unit 139. Further, the robot 100 stores mounting information and execution information.

The mounting information indicates information on a mechanism and a function mounted on the robot 100. Sensor information 141 is information on a sensor included in the robot 100. For example, the sensor information 141 includes information on the sensor mounted on the robot 100, such as whether the robot 100 includes an image sensor, an audio sensor (microphone or the like), or a sensor that measures acceleration, temperature, humidity, or the like. The sensor information 141 may also include not only whether such a sensor is mounted but also detailed information such as specifications of each sensor. The sensor information 141 may also include information such as whether there is an input/output device such as a touch panel. Besides, the sensor information 141 may also include information on whether there are various known sensors and their specifications.

Recognizer information 142 indicates information on a recognition function of the robot 100. For example, the recognizer information 142 includes information indicating whether the robot 100 has a human recognition function of recognizing that a person is present using an image sensor, a face recognition function of recognizing a face of a person, or a pose recognition function of recognizing a pose of a person. The recognizer information 142 may also include information such as whether the robot 100 has a voice recognition function and whether the robot has a recognition function based on characters input via a touch panel. Besides, the recognizer information 142 may also include information on whether there are various known recognizers and their specifications.

Working information 143 is information indicating a working status such as whether a sensor or a recognizer functions normally in the robot 100.

The execution information is information on various execution results obtained when the scenario is actually executed. Recognition result information 145 includes information such as a result (for example, a result of whether or not the robot 100 has recognized a person) recognized by the recognizer. Sensor acquisition information 146 includes results such as numerical values actually acquired and measured by the sensor.

The management unit 131 of the control unit 130 is configured to manage the various types of information described above. For example, the management unit 131 manages information on the sensor and the recognizer included in the robot 100. In addition, the management unit 131 scans the inside of the robot 100 at regular time intervals to manage whether the sensor and the recognizer work normally.

The robotics PF 135 is configured to receive a scenario from the user 20 and execute various kinds of processing for executing the received scenario in the robot 100.

The reception unit 136 is configured to receive a scenario from the user 20. The determination unit 137 is configured to determine whether or not the received scenario can be executed by the robot 100 based on the mounting information. For example, the determination unit 137 acquires information on a sensor and a recognizer used in the scenario, and determines whether or not the scenario can be actually executed, such as whether the sensor and the recognizer are included in the robot 100 or whether they work normally in the robot 100.

The execution unit 138 is configured to execute various kinds of processing for implementing the received scenario in the robot 100. The proposal unit 139 is configured to propose an alternative plan to the user 20 if it is determined that the scenario is difficult to execute. For example, in a case where the robot 100 receives a scenario requiring an image sensor but the robot 100 is not equipped with the image sensor, the proposal unit 139 proposes an alternative means for executing the scenario without using the image sensor.

### 1-2. Procedure of Proposal Processing According to Embodiment

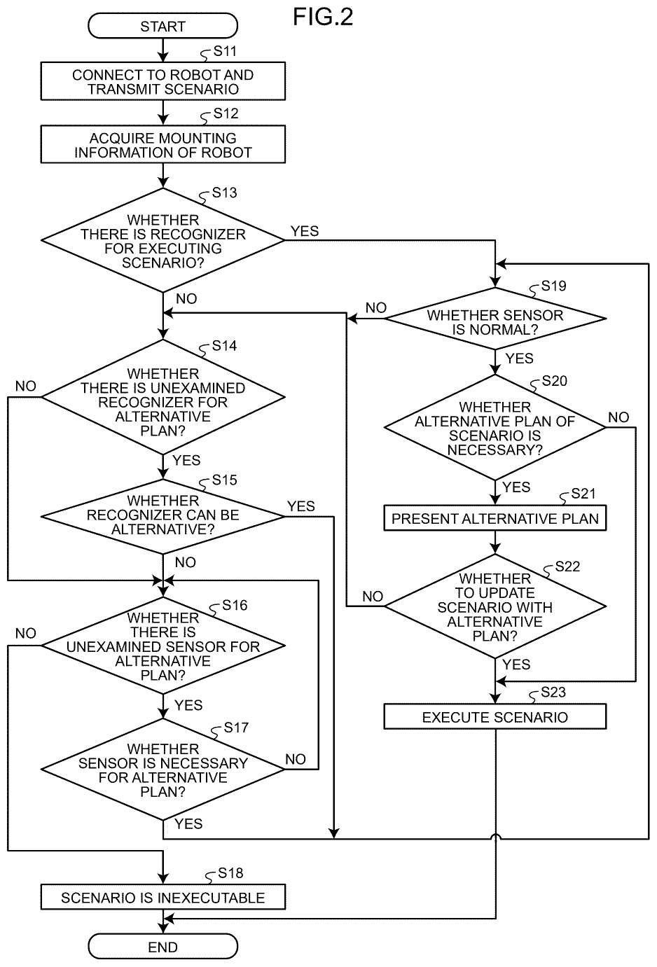

Next, a procedure executed when the robot 100 actually determines and executes a scenario will be described with reference to FIG. 2. FIG. 2 is a flowchart illustrating an example of a procedure of the proposal processing according to the embodiment. Note that, in the following, an example where the robot 100 performs processing such as scenario determination in the robot 100 itself will be illustrated, but the following processing may be remotely executed on a terminal visually recognizable by the user 20 under an operation by the user 20. Further, in the following, an example where the robot 100 having received the scenario determines whether the function or the like for executing the scenario is mounted on the robot 100 itself will be illustrated, but such determination processing and execution control of the robot 100 based on the scenario may be performed on the robot 100 by a terminal operated by the user 20.

First, the user 20 connects to the robot 100 and transmits the created scenario to the robot 100 (Step S11). Upon receiving the scenario, the robot 100 acquires the mounting information of the robot 100 (Step S12).

Subsequently, the robot 100 analyzes the scenario and determines whether a function or the like for executing the scenario in the robot 100 is mounted on the robot. First, the robot 100 determines whether a recognizer for executing the scenario is mounted on the robot 100 (Step S13).

If the recognizer for executing the scenario is not mounted (Step S13; No), the robot 100 determines whether or not there is an unexamined recognizer that can be an alternative plan (Step S14). If such a recognizer is found (Step S14; Yes), the robot 100 determines whether or not this recognizer can be an alternative plan (Step S15). Note that, the robot 100 determines whether or not the found recognizer can be an alternative plan based on preset condition information and the like, which will be described in detail later.

If the found recognizer cannot be an alternative plan (Step S15; No), or if there is no unexamined recognizer in Step S14 (Step S14; No), the robot 100 determines whether or not there is an unexamined sensor that can be an alternative plan (Step S16). If such a sensor is found (Step S16; Yes), the robot 100 determines whether or not this sensor is a sensor necessary for the alternative plan (Step S17). If the sensor is not a sensor necessary for the alternative plan (Step S17; No), the robot 100 further searches for another sensor (Step S16), and if no sensor available for the alternative plan is found even after all the sensors have been searched (Step S16; No), the robot determines that the received scenario is inexecutable (Step S18).

On the other hand, if the sensor is a sensor necessary for the alternative plan (Step S17; Yes), or if there is an alternative recognizer in Step S15 (Step S15; Yes), the robot 100 determines whether or not the sensor work normally (Step S19). Note that, if determining in Step S13 that the recognizer for executing the scenario is mounted on the robot 100 (Step S13; Yes), the robot 100 similarly determines whether or not the sensor for causing the recognizer to function works normally (Step S19).

If the sensor does not work normally (Step S19; No), it means the sensor or the recognizer does not work, so that the robot 100 searches for an alternative plan (Step S14).

On the other hand, if the sensor works normally (Step S19; Yes), the robot 100 determines whether or not it is necessary to present an alternative plan of the scenario to the user 20 (Step S20). For example, if the processing procedure has shifted from Step S13 to Step S19, the robot 100 determines that the scenario can be executed without an alternative plan, and thus determines that the alternative plan does not need to be presented (Step S20; No).

On the other hand, if the processing procedure has shifted from Step S17 to Step S19, the robot 100 determines that an alternative plan is necessary, and thus determines that the alternative plan needs to be presented (Step S20; Yes). In this case, the robot 100 presents an appropriate alternative plan to the user 20 (Step S21).

In this case, the robot 100 determines whether or not to update the scenario with the alternative plan according to a request of the user 20 or the like (Step S22). Note that, the robot 100 may automatically determine whether or not to adopt the alternative plan regardless of a response from the user 20. If determining not to update the scenario with the alternative plan (Step S22; No), the robot 100 returns the processing to Step S14 in order to search for a different alternative plan.

On the other hand, if determining to update the scenario with the alternative plan (Step S22; Yes), the robot 100 updates the received scenario with the alternative plan, and then executes the scenario (Step S23). Note that, if determining in Step S20 that an alternative plan is unnecessary (Step S20; No), the robot 100 executes the scenario with the originally received content (Step S23).

### 1-3. Specific Example of Proposal Processing According to Embodiment

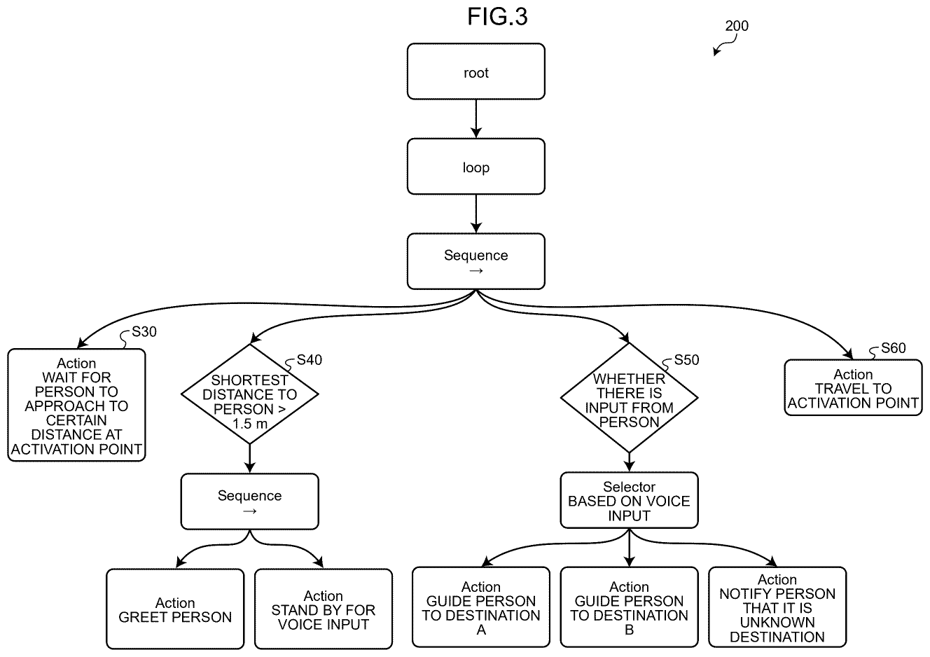

Next, the proposal processing according to the embodiment will be described in detail while showing an example of a specific scenario. FIG. 3 is a diagram (1) illustrating the proposal processing according to the embodiment.

FIG. 3 illustrates a scenario 200. In the example illustrated in FIG. 3, the scenario 200 is a definition document in which behaviors for the robot 100 to guide a person are set in advance, and has a configuration in which nodes indicating the behaviors of the robot 100 are combined. Note that, the scenario 200 illustrated in FIG. 3 illustrates that action processing and determination processing sequentially shift from left to right.

For example, as actions of the robot, the scenario 200 includes “wait for a person to approach to a certain distance at the activation point” (Step S30). Specifically, the robot 100 continues to wait for a person to approach until the person approaches to within a preset certain distance.

At this time, the robot 100 determines whether or not the person has approached to the extent that the shortest distance between the robot 100 and the person is closer than 1.5 meters (Step S40). If the person has approached to the extent that the distance between the robot 100 and the person is closer than 1.5 meters, the robot 100 takes an action of “greet the person” as defined in the scenario 200. The robot 100 also stands by so as to receive some voice input from the person.

Thereafter, the robot 100 determines whether or not the robot has received an input from the person (Step S50). If not receiving any input from the person, the robot 100 continues to stand by. Upon receiving an input from the person, the robot 100 determines subsequent processing based on the content of the voice input. For example, the robot 100 takes an action of “guide the person to a destination A”, “guide the person to a destination B”, or “notify the person that it is an unknown destination” based on an analysis result of a voice input from the person. For example, in a case where the person inputs a voice having a content such as “I want to go to the destination A” to the robot 100, the robot 100 determines to take an action of “guide the person to the destination A” based on such a voice input.

Thereafter, the robot 100 takes the action determined in Step S50. Specifically, the robot 100 starts traveling to the activation point (in the example of the scenario 200, a preset destination such as the destination A or the destination B) (Step S60).

As described above, the scenario 200 includes the content of the actions and branches of the robot 100 desired by the user 20 who is a scenario creator. In other words, by receiving the scenario 200, the robot 100 can guide a person or go to a destination according to the content defined in the scenario 200.

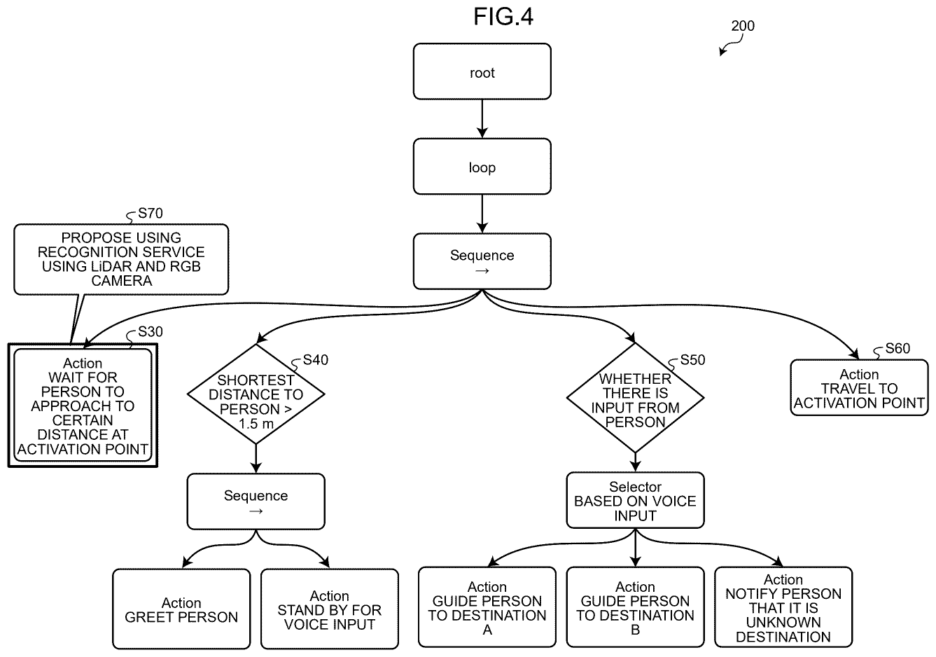

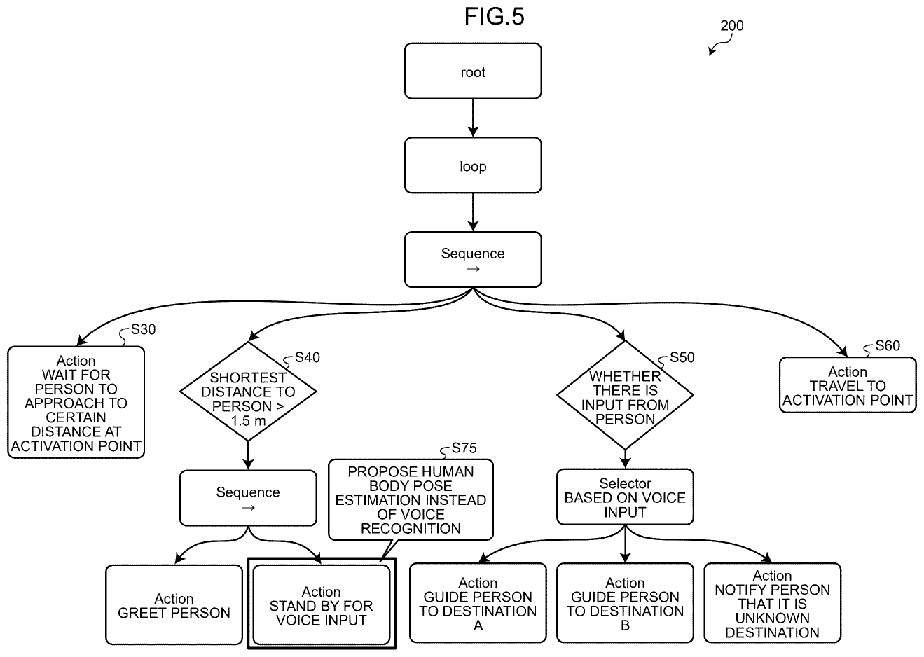

However, the robot 100 may not be able to directly execute the scenario 200 depending on the mechanism and function mounted on the robot 100. In this case, the robot 100 presents an alternative plan in line with the proposal processing according to the present disclosure. This processing will be described with reference to FIGS. 4 and 5. FIG. 4 is a diagram (2) illustrating the proposal processing according to the embodiment.

For example, at the time of receiving the scenario 200, the robot 100 determines whether or not the robot can execute the scenario 200 without any problem. Specifically, the robot 100 determines whether or not the recognizer or sensor of the robot 100 does not hinder executing the action defined in Step S30 (“wait for a person to approach to a certain distance at the activation point”).

First, the robot 100 acquires the mounting information of the robot 100, and determines whether a recognizer or a sensor necessary for the action is mounted or whether the recognizer or the sensor operates without any problem. For example, the robot 100 acquires information indicating that the robot is equipped with an RGB camera, light detection and ranging (LiDAR), and a speaker as sensors and mechanisms, but does not have a microphone. In this case, the robot 100 determines that the human recognition function is available but voice recognition (input) is not possible as the recognizer information. The robot 100 also determines that the robot has a time of flight (ToF) sensor but a distance measuring function or the like is unavailable due to a failure of the sensor. The robot 100 accumulates these pieces of information inside the robot 100 and then presents an alternative plan to the user 20.

For example, in execution of Step S30, the robot 100 determines that, instead of using the distance measurement function using the ToF sensor, image recognition using LiDAR or an RGB camera can substitute for this function. In this case, the robot 100 presents an alternative plan that a recognition service (such as an image recognition function) using LiDAR or an RGB camera can be used instead of the distance measurement function using the ToF sensor (Step S70).

As described above, according to the proposal processing of the embodiment, the robot 100 can acquire the functions and the like available in the robot 100, determine whether the robot can execute each action included in the scenario 200, and present an alternative plan if it is difficult to execute the action. As a result, the user 20 can cause the robot 100 to execute the action defined in the scenario 200 without rewriting the scenario 200.

Another example of such proposal processing will be described with reference to FIG. 5. FIG. 5 is a diagram (3) illustrating the proposal processing according to the embodiment.

The robot 100 that has acquired the mounting information of the robot 100 in FIG. 4 determines that the robot 100 does not have a microphone and thus cannot receive a voice input from a person. In this case, the robot 100 determines that the action of “stand by for voice input”, which is subsequent processing of Step S40, is impossible.

Here, since the robot 100 can perform image recognition using LiDAR or an RGB camera, the robot determines that it can receive an input by “human pose recognition” such as a person pointing a direction of a destination instead of voice input. In this case, the robot 100 proposes to perform human body pose estimation instead of voice recognition (Step S75). As described above, in a case where an action required to receive some input from a person is defined in the scenario 200, the robot 100 proposes an alternative input means instead of an input means using a sensor or a recognizer not mounted on the robot 100. As a result, the user 20 can cause the robot 100 to execute the receipt of input defined in the scenario 200 without rewriting the scenario 200.

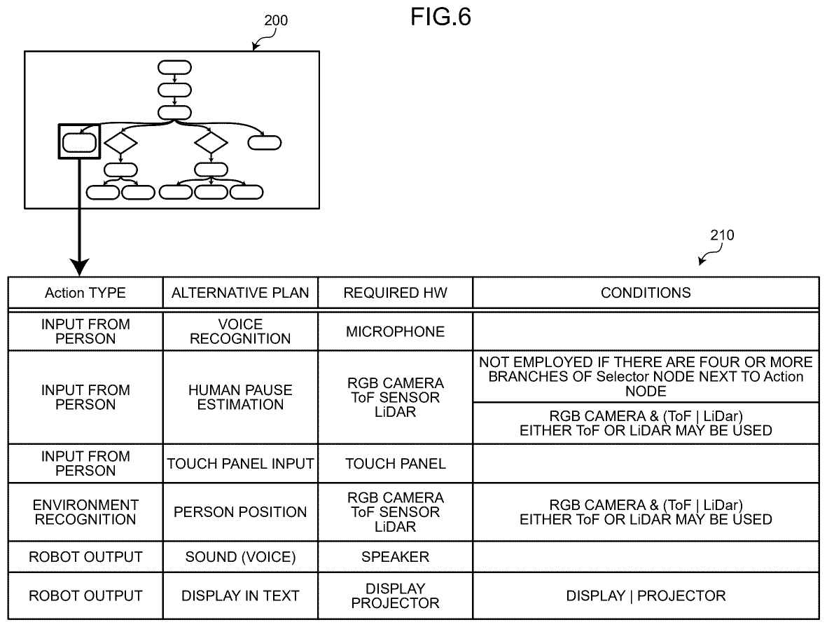

The alternative proposal processing illustrated in FIGS. 4 and 5 can be implemented by, for example, rule processing according to a data table illustrated in FIG. 6. FIG. 6 is a diagram illustrating an example of a data table 210 related to the proposal processing.

The data table 210 is a data table in which a type of action, an alternative plan for the action, hardware (HW) (such as a sensor and an operation mechanism) necessary for executing the alternative plan, a condition for employing the alternative plan, and the like are associated with each other. Note that, the data table 210 may be included in all the robots 100 having the robotics PF 135 as a file common to the robotics PF 135, or may be assigned to a scenario transmitted to the robot 100. Alternatively, the data table 210 may be held in a cloud server or the like accessible by the robotics PF 135.

As an example, as illustrated in FIGS. 4 and 5, it is assumed that the robot 100 determines that there is a failure in the mounted ToF sensor. In this case, the robot 100 determines a node (action) to be affected by the failure of the ToF sensor in the scenario 200, and refers to the data table 210 to search for an alternative plan of the action related to the ToF sensor.

For example, in the example of FIG. 4, the action of “wait for a person to come nearby” is defined in the scenario 200, and the ToF sensor is usually used for such recognition. At this time, the robot 100 searches for a means for performing such recognition without using the ToF sensor. First, the robot 100 refers to the data table 210, determines the type of the action, and determines that the type belongs to “environment recognition”. Then, the robot 100 refers that the condition for executing “human recognition” as an alternative plan thereof includes any one of “RGB camera”, “ToF sensor”, and “LiDAR”. Since the robot 100 includes “RGB camera” and “LiDAR”, the robot 100 determines that there is no problem in executing human recognition. Therefore, the robot 100 can propose “human recognition” as an alternative plan not using the ToF sensor.

Further, in the example of FIG. 5, “stand by for voice input” in the subsequent processing of Step S40 becomes a problem. For example, in a case where the action is “input from a person”, the example indicates that the data table 210 may present “voice recognition”, “human pose estimation”, “touch panel input”, or the like as an alternative plan. For example, when the robot 100 determines that a certain action corresponds to “input from a person” (“stand by for voice input” in the example of FIG. 5) and that the robot cannot take the action, the robot searches the data table 210 for an alternative plan. In this example, since the robot 100 cannot perform voice input, the robot presents “human pose estimation”, “touch panel input”, and the like, which are other alternative plans, as an alternative plan.

At this time, when presenting the alternative plan, the robot 100 determines whether the robot includes a sensor necessary for executing the alternative plan or whether a condition for presenting the alternative plan is met. For example, in a case where the robot 100 is not equipped with an RGB camera, a ToF sensor, or LiDAR, the robot 100 does not propose “human pose estimation” but presents “touch panel input”.

In the example of FIG. 5, since the robot 100 includes an RGB camera and LiDAR, the robot 100 presents “human pose estimation” as an alternative plan of voice input. Note that, in a case where the robot 100 includes a touch panel, the robot 100 may propose “touch panel input” instead of “human pose estimation”.

Meanwhile, as another example, in a case where the action of “greet a person” is incorporated in the scenario, if the robot 100 determines that the robot does not have a voice output function, the robot searches the data table 210 for an alternative output means. In the example of FIG. 6, the robot 100 can search for “display in text” as an alternative plan of voice output. In this case, instead of greetings by voice output, the robot 100 proposes an alternative plan to output characters corresponding to greetings to the user 20 using a display or a projector output provided in the robot 100. The proposal processing executed by the robot 100 is

implemented, for example, according to the procedures of Step S14, Step S15, Step S17, Step S19, and the like illustrated in FIG. 2. As described above, since the robot 100 can propose an alternative plan of each action when receiving the scenario 200, it is possible to determine the feasibility of the scenario 200 before actually executing the scenario, and update the scenario 200 so as to be feasible.

### 1-4. Example of User Interface of Proposal Processing

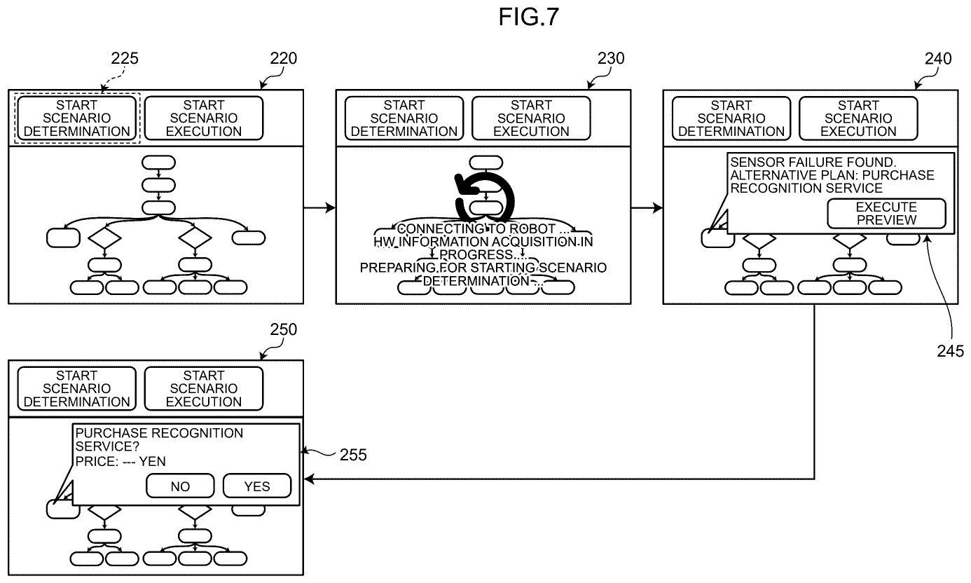

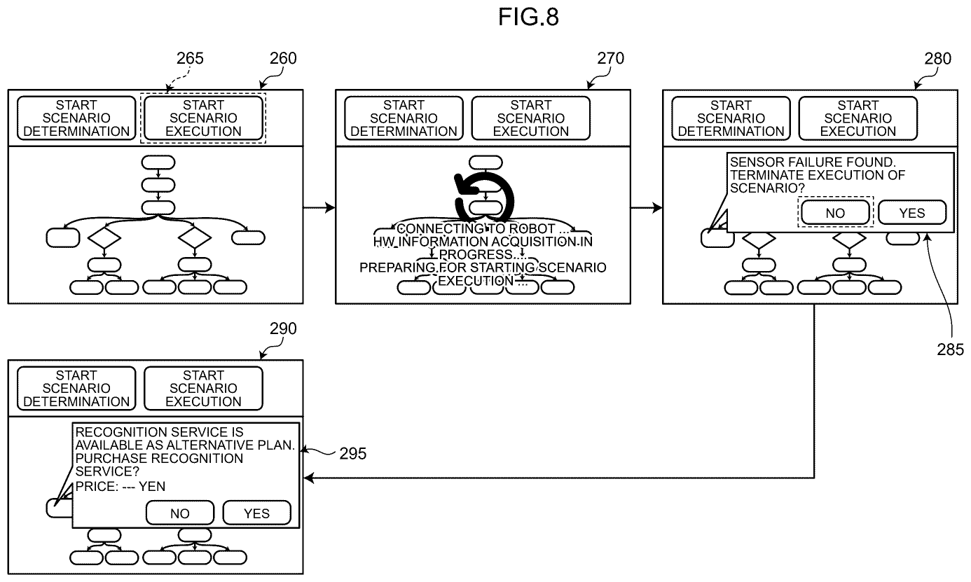

Next, an example of the user interface at the time of executing the above proposal processing will be described in detail with reference to FIGS. 7 and 8. FIG. 7 is a diagram illustrating the example of the user interface in scenario determination processing according to the embodiment.

FIG. 7 illustrates a state of the user interface observed when the user 20 determines whether the created scenario operates on the robot 100 before causing the robot 100 to execute the scenario. In the example of FIG. 7, the user interface is a screen displayed on an information processing terminal or the like operated by the user 20.

A first screen 220 illustrated in FIG. 7 is an example of an execution screen of the scenario editor, for example, and is a screen used when the user 20 determines whether the scenario created by the user actually operates without any problem when the scenario is loaded into the robot 100. The user 20 can execute the scenario determination processing by selecting a scenario determination start button 225 on the first screen 220.

When the user 20 selects the scenario determination start button 225, the first screen 220 shifts to a second screen 230. The second screen 230 indicates that the scenario created by the user 20 is being loaded into the robot 100, the mounting information and the like inside the robot 100 are being checked, and processing of whether or not the scenario operates without any problem is being executed.

When the result of the determination processing in the robot 100 is output, the second screen 230 shifts to a third screen 240. In the example of FIG. 7, it is assumed that the robot 100 determines that there is a failure in one of the sensors to be used in the scenario. The determination result by the robot 100 is displayed on the third screen 240. Specifically, the third screen 240 displays a proposal 245 to the user 20 such as “Sensor failure has been found. Alternative plan: purchase of recognition service”.

The above proposal 245 indicates that, since there is a sensor failure, it is necessary to acquire a recognizer (recognition service) which the robot 100 is not currently equipped with in order to execute the scenario. Further, the proposal 245 includes a preview execution button. When the user 20 selects the preview execution button, the robot 100 acquires, via the network, the recognition service (such as a program related to recognition processing) presented as the alternative plan. Then, the robot 100 presents to the user 20 that the recognition processing is executed without any problem by the acquired recognition service. For example, the robot 100 presents to the user 20 that the acquired recognition service operates without any problem by projecting the surrounding environment recognized by the robot 100 (such as a peripheral situation captured by the camera) on the screen.

Thereafter, the third screen 240 shifts to a fourth screen 250. The fourth screen 250 displays a proposal 255 such as “Purchase recognition service?”. The proposal 255 is a proposal for prompting the user 20 to actually purchase the recognition service that the user 20 has checked on the preview. The user 20 can execute the created scenario in the robot 100 by purchasing the recognition service from a provider (such as a business operator that sells the recognition service). Note that, if the user 20 rejects the alternative plan, the robot 100 may further display a different alternative plan.

In this manner, once creating the scenario, the user 20 can simulate, on the user interface, whether the scenario operates to the end without any problem without actually operating the robot 100. As a result, the user 20 can quickly and reliably grasp the feasibility of the scenario. Further, the user 20 can operate the scenario on various robots by acquiring a necessary recognition service via the user interface, for example.

Next, an example of the user interface observed when the scenario is actually operating in the robot 100 will be described in detail with reference to FIG. 8. FIG. 8 is a diagram illustrating an example of the user interface in the scenario execution processing according to the embodiment.

FIG. 8 illustrates a state of the user interface displayed when the user 20 causes the robot 100 to execute the created scenario. In the example of FIG. 8, similarly to FIG. 7, the user interface is a screen displayed on an information processing terminal or the like operated by the user 20.

A fifth screen 260 illustrated in FIG. 8 is a screen displayed when the scenario created by the user 20 is loaded into the robot 100. The user 20 can cause the robot 100 to execute the scenario by selecting a scenario execution start button 265 on the fifth screen 260.

When the user 20 selects the scenario execution start button 265, the fifth screen 260 shifts to a sixth screen 270. The sixth screen 270 indicates that the scenario created by the user 20 is being loaded into the robot 100, the mounting information and the like inside the robot 100 are being checked, and processing for executing the scenario is being executed.

When the robot 100 starts executing the scenario, the sixth screen 270 shifts to a seventh screen 280. In the example of FIG. 8, it is assumed that the robot 100 determines that there is a failure in one of the sensors while executing the scenario. The determination result by the robot 100 is displayed on the seventh screen 280. Specifically, the seventh screen 280 displays a proposal 285 to the user 20 such as “Sensor failure has been found. Terminate execution of scenario?”.

If terminating the execution of the scenario, the user 20 selects “Yes” in the proposal 285. As a result, the robot 100 terminates the execution of the scenario.

On the other hand, if not terminating the execution of the scenario, the user 20 selects “No” in the proposal 285. In this case, the robot 100 proposes an alternative for not terminating the scenario. The seventh screen 280 shifts to an eighth screen 290.

The eighth screen 290 displays a proposal 295 such as “Recognition service is available as alternative plan. Purchase recognition service?”. The proposal 295 includes contents that is obtained by causing the robot 100 to search for a substitute recognizer or sensor (such as hardware) in order to complete the action defined in the scenario without terminating the scenario and that can be proposed to the user 20 as an alternative plan based on the search result. Similarly to the example of FIG. 7, the user 20 can continue causing the robot 100 to execute the created scenario by purchasing the recognition service from the provider. Note that, if the user 20 rejects the alternative plan, the robot 100 may further display a different alternative plan.

As described above, even when the robot 100 is executing the scenario, when there is a problematic action, the user 20 can immediately update the scenario by the proposal processing by the robot 100. As a result, the user 20 can reliably achieve the robot 100's stable operation irrespective of whether the scenario and the robot 100 are compatible.

Note that, FIGS. 7 and 8 illustrate an example in which the robot 100 proposes purchase of a recognition service, but the alternative plan is not limited to purchase, and for example, in a case where some available service (program) is searched for, the robot 100 may propose acquisition of the service. Alternatively, in a case where a failure is found in a certain sensor (for example, a ToF sensor), the robot 100 may propose to perform processing using another substitutable sensor (for example, an RGB camera). In addition, in the case of substitution of a sensor, the robot 100 may automatically update the scenario to automatically use an alternative sensor without proposal.

As has been described with reference to FIGS. 1 to 8, the robot 100 manages the mounting information of the robot 100, and determines the feasibility of a scenario upon receiving the scenario, thereby performing processing for causing the scenario to operate in the robot 100. Further, if the scenario is difficult to operate in the robot 100, the robot 100 proposes an alternative plan to the user 20. As a result, the robot 100 can generally use the scenario irrespective of the mechanisms and functions of the robot, and thus it is possible to enhance the convenience of the user regarding robot control.

### 1-5. Configuration Example of Robot According to Embodiment

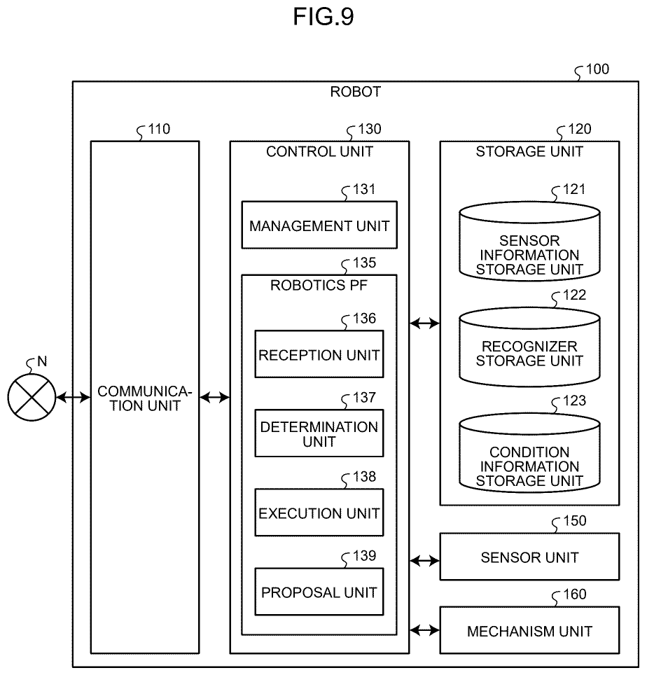

Next, a configuration of the proposal device (robot 100) according to the present disclosure will be described with reference to FIG. 9. FIG. 9 is a diagram illustrating a configuration example of the robot 100 according to the embodiment.

As illustrated in FIG. 9, the robot 100 includes: a communication unit 110; a storage unit 120; and a control unit 130. Note that, the robot 100 may include an input unit (such as a keyboard or a touch display) that receives various operations from an administrator who manages the robot 100, the user 20, or the like, and a display unit (such as a liquid crystal display) for displaying various types of information.

The communication unit 110 is implemented by, for example, a network interface card (NIC), a network interface controller, or the like. The communication unit 110 is connected to a network N in a wired or wireless manner, and transmits and receives information to and from an information terminal, an external device, or the like used by the user 20 via the network N. The network N is implemented by, for example, a wireless communication standard or system such as Bluetooth (registered trademark), the Internet, Wi-Fi (registered trademark), Ultra Wide Band (UWB), or Low Power Wide Area (LPWA).

The storage unit 120 is implemented by, for example, a semiconductor memory element such as a random access memory (RAM) and a flash memory, or a storage device such as a hard disk and an optical disk.

The storage unit 120 stores various types of information for performing the proposal processing according to the embodiment. The storage unit 120 includes, for example: a sensor information storage unit 121 that stores information on a sensor mounted on the robot 100; a recognizer storage unit 122 that stores information on a recognizer; a condition information storage unit 123 that stores conditions such as execution of a scenario and an alternative plan; and the like. The sensor information storage unit 121 and the recognizer storage unit 122 correspond to the mounting information and the like illustrated in FIG. 1. The condition information storage unit 123 corresponds to the execution information illustrated in FIG. 1 and the data table 210 illustrated in FIG. 6.

A sensor unit 150 indicates various sensors mounted on the robot 100. For example, an example of the sensor unit 150 is a ToF sensor, LiDAR, camera, and the like. Note that, the camera may have any form such as a stereo camera, a monocular camera, or a lensless camera. Further, the camera is not limited to a visible light camera such as an RGB camera, and may be a camera with a depth sensor or the like including a ToF sensor. Furthermore, the camera may include an AI-equipped image sensor capable of detecting and recognizing an object.

The sensor unit 150 may also include various sensors in addition to the LiDAR and camera. For example, the sensor unit 150 may include a distance measuring system using a millimeter wave radar. In addition, the sensor unit 150 may include a depth sensor for acquiring depth data. Further, the sensor unit 150 may be a sonar that searches for a surrounding environment by a sound wave. Furthermore, the sensor unit 150 may include a microphone that collects sound around the robot 100, an illuminance sensor that detects illuminance around the robot 100, a humidity sensor that detects humidity around the robot 100, a geomagnetic sensor that detects a magnetic field at a location of the robot 100, and the like.

A mechanism unit 160 indicates a mechanism for operating the robot 100. For example, the mechanism unit 160 includes various mechanisms such as a motor for causing the robot 100 to autonomously operate and a wheel operated by the motor. In addition, the mechanism unit 160 may include various mechanisms (such as a speaker and an LED lamp) for outputting sound, light display, and the like. Besides, the mechanism unit 160 may include any known mechanism for moving the robot 100 or for the robot 100 to output some information.

As described above with reference to FIG. 1, the control unit 130 is implemented by, for example, a CPU, an MPU, a GPU, or the like executing a program (such as the proposal program according to the present disclosure) stored in the robot 100 using a RAM or the like as a work area. Further, the control unit 130 is a controller, and may be implemented by, for example, an integrated circuit such as an application specific integrated circuit (ASIC) or a field programmable gate array (FPGA).

As described with reference to FIG. 2 and subsequent figures, the control unit 130 executes various kinds of processing for implementing the proposal processing according to the present disclosure. Hereinafter, processing of each unit other than those already described in FIG. 1 will be described.

The reception unit 136 receives a scenario that is for controlling the behavior of the robot 100 and is commonly used among different robots. For example, the reception unit 136 receives a scenario from the user 20 and loads the received scenario into the robot 100 so that the robot 100 can execute the scenario.

The determination unit 137 determines whether or not the functions or mechanisms of a device on which the control unit 130 is mounted (which is a device that executes a scenario, means a target for which its mounted functions or the like are determined, and corresponds to the robot 100 in the embodiment) satisfy the requirements for executing the acquired scenario.

For example, the determination unit 137 determines whether or not a recognizer as the function mounted on the robot 100 satisfies the requirements for executing the scenario. Specifically, the determination unit 137 determines that the recognizer does not satisfy at least one of the requirements of image recognition, voice recognition, and distance recognition for executing the scenario. For example, in a case where an action of recognizing a person is set in the scenario, the determination unit 137 determines whether or not the robot 100 can perform image recognition for recognizing a person. Alternatively, in a case where an action for determining whether or not a person has approached to within a predetermined distance is set in the scenario, the determination unit 137 determines whether or not distance recognition for determining the distance to the person is possible in the robot 100.

Further, the determination unit 137 may determine whether or not a sensor as the mechanism for executing the scenario is mounted on the robot 100. Alternatively, the determination unit 137 may determine whether or not the sensor as the mechanism for executing the scenario works normally in the robot 100.

Further, the determination unit 137 determines whether or not an output unit as the mechanism for executing the scenario is mounted on the robot 100. The output unit means a mechanism for outputting some information to the outside. Specifically, the determination unit 137 determines whether or not a voice output unit (such as a speaker) for executing the scenario is mounted on the robot 100. Note that, the determination unit 137 may determine whether or not a video output unit (such as a projector or a display) is mounted on the robot 100 as an output unit.

Further, the determination unit 137 may determine whether or not a moving mechanism as the mechanism for executing the scenario is mounted on the robot 100. The moving mechanism is a mechanism for causing the robot 100 to autonomously move, and means, for example, a leg or a wheel of the robot 100, or a power unit such as a motor for operating them.

The execution unit 138 executes the scenario received by the reception unit 136. Note that, as described in FIG. 8, the execution unit 138 may execute determination processing similar to the determination performed by the determination unit 137 while executing the scenario as appropriate.

The proposal unit 139 proposes an alternative means for executing the scenario if the determination unit 137 or the execution unit 138 determines that it is difficult to execute the scenario.

For example, in a case where there is a recognizer determined not to satisfy the requirements, the proposal unit 139 proposes a recognition means to substitute for the recognizer. Specifically, the proposal unit 139 proposes a recognition service that is available via a network as the recognition means. For example, the proposal unit 139 accesses a server of a business operator that provides a recognition service, searches for a recognition service available in the scenario, and presents a search result to the user 20.

In a case where there is a recognizer determined not to satisfy the requirements, the proposal unit 139 proposes at least one recognition means of image recognition, voice recognition, and distance recognition that substitutes for the recognizer not satisfying the requirements. For example, in a case where it is determined that image recognition is not available in the robot 100, the proposal unit 139 proposes a recognizer related to voice recognition or distance recognition as an alternative means thereof. Note that, the image recognition, voice recognition, distance recognition, and the like are examples, and the proposal unit 139 may propose any means as long as it is a means capable of executing the scenario in place of these.

Further, in a case where no sensor is mounted on the robot 100, the proposal unit 139 proposes a recognition means that substitutes for the sensor. In addition, the proposal unit 139 may propose a recognition means that substitutes for the sensor in a case where the sensor does not work normally. For example, in a case where there is a failure in the RGB camera, the proposal unit 139 may propose use of another sensor such as LiDAR.

When no output unit is mounted on the robot 100, the proposal unit 139 may propose an output means that substitutes for the output unit. Specifically, in a case where no voice output unit (such as a speaker) is mounted on the robot 100, the proposal unit 139 proposes a display output means (such as display in text on a display) that substitutes for the voice output unit.

Further, in a case where no moving mechanism is mounted on the robot 100, the proposal unit 139 may propose an output means that substitutes for the moving mechanism. Specifically, in a case where no moving mechanism is mounted on the robot 100, the proposal unit 139 proposes, as an alternative plan, an output means (such as pointing a target direction with LED light) capable of instructing a movement destination set by the scenario.

Note that, in a case where the proposed alternative means is approved, the proposal unit 139 may update the scenario based on the alternative means. For example, in a case where the user 20 approves the purchase of the recognition service proposed as the alternative plan, the proposal unit 139 automatically updates the scenario so as to execute the scenario using the recognition service.

### 1-6. Modified Example

### (1-6-1. Device Configuration)

The robot 100 according to the embodiment is merely for conceptually illustrating functions, and various modes can be made depending on embodiments. For example, the robot 100 may include two or more devices different for the respective functions described above. As an example, the robot 100 may be configured as a cloud server and an edge connected via a network.

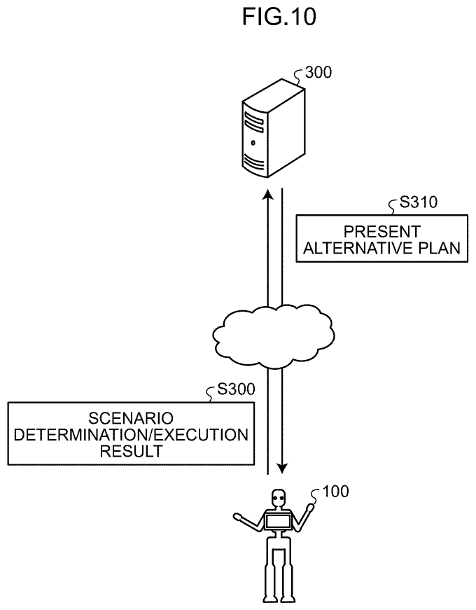

This point will be described with reference to FIG. 10. FIG. 10 is a diagram illustrating an outline of proposal processing according to a modified example. In the example of FIG. 10, when the scenario determination processing or the scenario execution processing is performed in the robot 100 (Step S300), the robot 100 transmits the result to a cloud server 300. The cloud server 300 refers to the determination result and the execution result, creates a suitable alternative plan, and presents the created alternative plan to the robot 100 (Step S310).

The robot 100 executes the presented alternative plan or proposes the alternative plan to the user 20. As described above, the robot 100 can reduce the processing load of the robot 100 by causing the cloud server 300 to execute the proposal processing with heavy load.

### (1-6-2. Mode of Proposal Device)

The robot 100 is not necessarily limited to one that autonomously moves, and may be a smart speaker, a smart home appliance such as a television, a wearable device such as a smart watch, or the like.

### (1-6-3. Mode of Proposal Processing)

The proposal processing is not necessarily implemented as processing based on a rule like processing based on an alternative plan defined in advance in the data table 210. For example, the robot 100 may learn results tried by multiple users and propose an alternative on the basis of the learning results.

For example, it is assumed that the robot 100 can use history information having been selected by multiple users in the past as an alternative plan of a certain action. In this case, the robot 100 may propose an alternative means for executing the scenario based on a history of the alternative means having been executed in other robots in the past. In a case where there are multiple alternative means for a certain action, the robot 100 may propose the multiple alternative means according to the order of priority set based on the history of execution of the alternative means in the past.

Specifically, the robot 100 may propose alternative plans to the user 20 while giving more priority to an alternative plan selected by a larger number of users. In addition, the robot 100 may omit proposal of processing, stored in the data table 210 as an alternative plan, if this alternative plan has been hardly selected in the past. As a result, the robot 100 can propose an alternative plan that tends to be used by a larger number of users, and thus can preferentially present an alternative plan that is supposed to contribute to solving the problem in reality to the user 20.

In addition, the robot 100 may propose an alternative plan not stored in the data table 210 to the user 20 if acquiring, from the history, information on the alternative plan such as a recognizer used to solve a certain action. As described above, the robot 100 does not necessarily have to be rule-based and, in a case where means that has actually solved the problem is shared, acquires such information to be able to propose a better alternative plan.

Further, in the embodiment, an example has been mainly described in which updating of software (program) in the case of using a sensor such as a recognition service is proposed as an alternative plan, but the robot 100 may propose an alternative mechanism or the like. For example, in a case where the robot 100 has no autonomous moving mechanism in an action of guiding a customer, the robot 100 may propose an action such as outputting light for pointing a direction of a destination or outputting a moving procedure by voice as an alternative plan.

Furthermore, when the robot 100 proposes an alternative plan, the robot may refer to an action corresponding to the alternative plan and a branch thereof in advance and propose only an alternative plan that may achieve the purpose in the subsequent branch. For example, in a case where there is an action that requires voice output in the subsequent branch in the scenario, the robot 100 can be configured not to propose an alternative plan that involves voice output prior to the branch. As a result, the robot 100 can avoid proposing a meaningless alternative plan to the user 20, whereby the convenience of the user 20 can be enhanced. Note that, even in this case, the robot 100 may propose all alternative plans to the user 20 with the intention of letting the user see what alternative plans exist.

### 2. Other Embodiments

The processing according to each embodiment described above may be performed in various different modes other than each embodiment described above.

Among the processing described in each embodiment described above, all or a part of the processing described as being automatically performed can be manually performed, or all or a part of the processing described as being manually performed can be automatically performed by a known method. Besides, the processing procedure, specific name, and information including various data and parameters illustrated in the above document and drawings can be arbitrarily changed unless otherwise specified. For example, the various types of information illustrated in the drawings are not limited to the illustrated information.

In addition, each component of each device illustrated in the drawings is functionally conceptual, and is not necessarily physically configured as illustrated in the drawings. In other words, the specific form of distribution and integration of each device is not limited to the illustrated form, and all or a part of the device can be functionally or physically distributed and integrated in an arbitrary unit according to various loads, usage conditions, and the like.

Further, the above-described embodiment and modifications can be appropriately combined within a range where their processing contents do not contradict each other.

Furthermore, the effects described in this specification are merely examples and are not limited, and other effects may be provided.

### 3. Effects of Proposal Method According to Present Disclosure

As described above, the proposal device (the robot 100 in the embodiment) according to the present disclosure includes, as the control unit: the reception unit (the reception unit 136 in the embodiment) that executes the reception procedure; the determination unit (the determination unit 137 in the embodiment) that executes the determination procedure; and the proposal unit (the proposal unit 139 in the embodiment) that executes the proposal procedure, and executes the proposal method according to the present disclosure. In the reception procedure, a scenario that is for controlling the behavior of the device and is commonly used among different devices is received. In the determination procedure, it is determined whether or not the function or mechanism mounted on the device equipped with the control unit (that is, the proposal device) satisfies the requirements for executing the received scenario. In the proposal procedure, if it is determined that it is difficult to execute the scenario, an alternative means for executing the scenario is proposed.

As described above, the proposal method according to the present disclosure reads a scenario that is common among robots, determines functions and the like required for executing the scenario, and proposes an alternative plan when it is difficult to execute the scenario. In other words, the proposal method makes it possible to execute the scenario regardless of which robot is used as long as such robots commonly have the basic function for enabling reading of the created scenario. As a result, the proposal method makes it possible to enhance user's convenience regarding robot control.

In addition, in the determination procedure, it is determined whether or not a recognizer as the function mounted on a device equipped with the control unit satisfies requirements for executing the scenario. In the proposal procedure, in a case where there is a recognizer determined not to satisfy the requirements, a recognition means that substitutes for the recognizer is proposed. For example, in the proposal procedure, a recognition service that is available via a network is proposed as the recognition means.

According to such a proposal method, the user can execute the scenario irrespective of the recognizer included in the robot, thus making it possible to reduce the burden for creating the scenario.

Further, in the determination procedure, it is determined whether the recognizer does not satisfy at least one of the requirements of image recognition, voice recognition, and distance recognition for executing the scenario. In the proposal procedure, in a case where there is a recognizer determined not to satisfy the requirements, at least one recognition means of image recognition, voice recognition, and distance recognition that substitutes for the recognizer not satisfying the requirements is proposed.

According to such a proposal method, it is possible to implement various alternative means, and thus possible to enhance the feasibility of the scenario by the robot.

In addition, in the determination procedure, it is determined whether or not a sensor as the mechanism for executing the scenario is mounted on the device equipped with the control unit. In the proposal procedure, in a case where no sensor is mounted on the device equipped with the control unit, a recognition means that substitutes for the sensor is proposed. Alternatively, in the determination procedure, it is determined whether or not the sensor as the mechanism for executing the scenario works normally in the device equipped with the control unit. In the proposal procedure, in a case where the sensor does not work normally, a recognition means that substitutes for the sensor is proposed.

According to such a proposal method, it is possible to execute the scenario even when there is a failure in the robot supposed to execute the scenario.

In addition, in the determination procedure, it is determined whether or not an output unit as the mechanism for executing the scenario is mounted on the device equipped with the control unit. In the proposal procedure, in a case where no output unit is mounted on the device equipped with the control unit, an output means that substitutes for the output unit is proposed. For example, in the determination procedure, it is determined whether or not a voice output unit for executing the scenario is mounted on the device equipped with the control unit. In the proposal procedure, in a case where no voice output unit is mounted on the device equipped with the control unit, a display output means that substitutes for the voice output unit is proposed.

According to such a proposal method, some output can be obtained from the robot regardless of the mode of the output means, thus making it possible to reduce the possibility of a failure such as making a customer or the like who interacts with the robot confused.

In addition, in the determination procedure, it is determined whether or not a moving mechanism as the mechanism for executing the scenario is mounted on the device equipped with the control unit. In the proposal procedure, in a case where no moving mechanism is mounted on the device equipped with the control unit, an output means that substitutes for the moving mechanism is proposed. For example, in the proposal procedure, in a case where no moving mechanism is mounted on the device equipped with the control unit, an output means capable of instructing a movement destination set by the scenario is proposed as an alternative plan.

According to such a proposal method, it is possible to cause the robot to execute the action intended by the scenario regardless of the moving mechanism of the robot.

In addition, in the proposal procedure, in a case where the proposed alternative means is approved, the scenario is updated based on the alternative means. Further, in the proposal procedure, an alternative means for executing the scenario may be proposed based on a history of the alternative means having been executed in other devices in the past. Furthermore, in the proposal procedure, in a case where there are multiple alternative means, the multiple alternative means may be proposed according to the order of priority set based on the history of the alternative means having been executed in the past.

According to such a proposal method, it is possible to implement alternative plan proposal processing which is not rule-based, and thus possible to flexibly cope with various situations.

### 4. Hardware Configuration

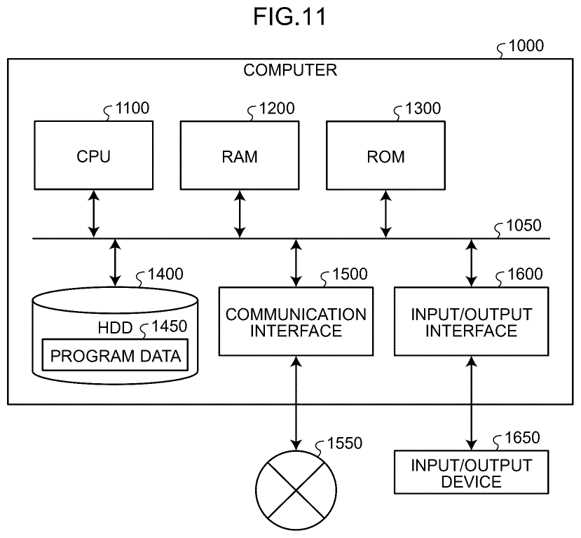

The information device such as the robot 100 according to each embodiment described above is implemented by a computer 1000 having a configuration as illustrated in FIG. 11, for example. Hereinafter, the robot 100 will be described as an example. FIG. 11 is a hardware configuration diagram illustrating an example of the computer 1000 that implements the functions of the proposal device (robot 100) according to the present disclosure. The computer 1000 includes: a CPU 1100; a RAM 1200; a Read Only Memory (ROM) 1300; a Hard Disk Drive (HDD) 1400; a communication interface 1500; and an input/output interface 1600. These units of the computer 1000 are connected to each other by a bus 1050.

The CPU 1100 operates on the basis of programs stored in the ROM 1300 or the HDD 1400, and controls each unit. For example, the CPU 1100 develops programs stored in the ROM 1300 or the HDD 1400 on the RAM 1200, and executes processing corresponding to the various programs.

The ROM 1300 stores a boot program such as a Basic Input Output System (BIOS) executed by the CPU 1100 when the computer 1000 is activated, a program dependent on hardware of the computer 1000, and the like.

The HDD 1400 is a computer-readable recording medium that non-transiently records a program executed by the CPU 1100, data used by the program, and the like. Specifically, the HDD 1400 is a recording medium that records a proposal program according to this disclosure as an example of program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, and a printer via the input/output interface 1600. Further, the input/output interface 1600 may function as a media interface that reads a program and the like recorded in a predetermined recording medium (medium). The medium is, for example, an optical recording medium such as a Digital Versatile Disc (DVD) or a Phase change rewritable Disk (PD), a magneto-optical recording medium such as a Magneto-Optical disk (MO), a tape medium, a magnetic recording medium, a semiconductor memory, and the like.

For example, in a case where the computer 1000 functions as the robot 100 according to the embodiment, the CPU 1100 of the computer 1000 implements the functions of the control unit 130 and the like by executing the proposal program loaded on the RAM 1200. In addition, the HDD 1400 stores the proposal program according to the present disclosure and data in the storage unit 120. Note that, the CPU 1100 reads the program data 1450 from the HDD 1400 and executes the program data, but as another example, these programs may be acquired from another device via the external network 1550.

Note that, the present technology can also have the following configuration.
(1) A proposal method comprising causing a control unit to execute:
   a reception procedure for receiving a scenario for controlling behavior of a device, the scenario being commonly used among different devices;
   a determination procedure for determining whether or not a function or a mechanism mounted on a device equipped with the control unit satisfies requirements for executing the received scenario; and
   a proposal procedure for proposing an alternative means for executing the scenario when it is determined that it is difficult to execute the scenario.
(2) The proposal method according to (1), wherein
   in the determination procedure, it is determined whether or not a recognizer as the function mounted on the device equipped with the control unit satisfies the requirements for executing the scenario, and
   in the proposal procedure, in a case where there is a recognizer determined not to satisfy the requirements, a recognition means that substitutes for the recognizer is proposed.
(3) The proposal method according to (2), wherein in the proposal procedure, a recognition service that is available via a network is proposed as the recognition means.
(4) The proposal method according to (2) or (3), wherein
   in the determination procedure, it is determined whether the recognizer does not satisfy at least one of the requirements of image recognition, voice recognition, and distance recognition for executing the scenario, and
   in the proposal procedure, in a case where there is a recognizer determined not to satisfy the requirements, at least one recognition means of image recognition, voice recognition, and distance recognition that substitutes for the recognizer not satisfying the requirements is proposed.
(5) The proposal method according to any one of (1) to (4), wherein
   in the determination procedure, it is determined whether or not a sensor as the mechanism for executing the scenario is mounted on the device equipped with the control unit, and
   in the proposal procedure, in a case where the sensor is not mounted on the device equipped with the control unit, a recognition means that substitutes for the sensor is proposed.
(6) The proposal method according to any one of (1) to (5), wherein
   in the determination procedure, it is determined whether or not a sensor as the mechanism for executing the scenario works normally in the device equipped with the control unit, and
   in the proposal procedure, in a case where the sensor does not work normally, a recognition means that substitutes for the sensor is proposed.
(7) The proposal method according to any one of (1) to (6), wherein
   in the determination procedure, it is determined whether or not an output unit as the mechanism for executing the scenario is mounted on the device equipped with the control unit, and
   in the proposal procedure, in a case where the output unit is not mounted on the device equipped with the control unit, an output means that substitutes for the output unit is proposed.
(8) The proposal method according to (7), wherein
   in the determination procedure, it is determined whether or not a voice output unit for executing the scenario is mounted on the device equipped with the control unit, and
   in the proposal procedure, in a case where the voice output unit is not mounted on the device equipped with the control unit, a display output means that substitutes for the voice output unit is proposed.
(9) The proposal method according to (7) or (8), wherein
   in the determination procedure, it is determined whether or not a moving mechanism as the mechanism for executing the scenario is mounted on the device equipped with the control unit, and
   in the proposal procedure, in a case where the moving mechanism is not mounted on the device equipped with the control unit, an output means that substitutes for the moving mechanism is proposed.
(10) The proposal method according to (9), wherein
   in the proposal procedure, in a case where the moving mechanism is not mounted on the device equipped with the control unit, an output means capable of instructing a movement destination set by the scenario is proposed as an alternative plan.
(11) The proposal method according to any one of (1) to (10), wherein
   in the proposal procedure, in a case where the proposed alternative means is approved, the scenario is updated based on the alternative means.
(12) The proposal method according to any one of (1) to (11), wherein
   in the proposal procedure, an alternative means for executing the scenario is proposed based on a history of the alternative means having been executed in other devices in the past.
(13) The proposal method according to any one of (1) to (12), wherein
   in the proposal procedure, in a case where there are a plurality of alternative means, the plurality of alternative means are proposed according to the order of priority set based on a history of the alternative means having been executed in the past.
(14) A proposal device comprising:
   a reception unit that receives a scenario for controlling behavior of a device, the scenario being commonly used among different devices;
   a determination unit that determines whether or not a function or a mechanism mounted on a device equipped with the reception unit satisfies requirements for executing the received scenario; and
   a proposal unit that proposes an alternative means for executing the scenario when it is determined that it is difficult to execute the scenario.
(15) A proposal program causing a computer to function as a proposal device comprising:
   a reception unit that receives a scenario for controlling behavior of a device, the scenario being commonly used among different devices;
   a determination unit that determines whether or not a function or a mechanism mounted on a device equipped with the reception unit satisfies requirements for executing the received scenario; and
   a proposal unit that proposes an alternative means for executing the scenario when it is determined that it is difficult to execute the scenario.

### REFERENCE SIGNS LIST

20 USER
100 ROBOT
110 COMMUNICATION UNIT
120 STORAGE UNIT
121 SENSOR INFORMATION STORAGE UNIT
122 RECOGNIZER STORAGE UNIT
123 CONDITION INFORMATION STORAGE UNIT
130 CONTROL UNIT
131 MANAGEMENT UNIT
135 ROBOTICS PF
136 RECEPTION UNIT
137 DETERMINATION UNIT
138 EXECUTION UNIT
139 PROPOSAL UNIT

1. A proposal method comprising causing a control unit to execute:
a reception procedure for receiving a scenario for controlling behavior of a device, the scenario being commonly used among different devices;
a determination procedure for determining whether or not a function or a mechanism mounted on a device equipped with the control unit satisfies requirements for executing the received scenario; and
a proposal procedure for proposing an alternative means for executing the scenario when it is determined that it is difficult to execute the scenario.

2. The proposal method according to claim 1, wherein
in the determination procedure, it is determined whether or not a recognizer as the function mounted on the device equipped with the control unit satisfies the requirements for executing the scenario, and
in the proposal procedure, in a case where there is a recognizer determined not to satisfy the requirements, a recognition means that substitutes for the recognizer is proposed.

3. The proposal method according to claim 2, wherein
in the proposal procedure, a recognition service that is available via a network is proposed as the recognition means.

4. The proposal method according to claim 2, wherein
in the determination procedure, it is determined whether the recognizer does not satisfy at least one of the requirements of image recognition, voice recognition, and distance recognition for executing the scenario, and
in the proposal procedure, in a case where there is a recognizer determined not to satisfy the requirements, at least one recognition means of image recognition, voice recognition, and distance recognition that substitutes for the recognizer not satisfying the requirements is proposed.

5. The proposal method according to claim 1, wherein
in the determination procedure, it is determined whether or not a sensor as the mechanism for executing the scenario is mounted on the device equipped with the control unit, and
in the proposal procedure, in a case where the sensor is not mounted on the device equipped with the control unit, a recognition means that substitutes for the sensor is proposed.

6. The proposal method according to claim 1, wherein
in the determination procedure, it is determined whether or not a sensor as the mechanism for executing the scenario works normally in the device equipped with the control unit, and
in the proposal procedure, in a case where the sensor does not work normally, a recognition means that substitutes for the sensor is proposed.

7. The proposal method according to claim 1, wherein
in the determination procedure, it is determined whether or not an output unit as the mechanism for executing the scenario is mounted on the device equipped with the control unit, and
in the proposal procedure, in a case where the output unit is not mounted on the device equipped with the control unit, an output means that substitutes for the output unit is proposed.

8. The proposal method according to claim 7, wherein
in the determination procedure, it is determined whether or not a voice output unit for executing the scenario is mounted on the device equipped with the control unit, and
in the proposal procedure, in a case where the voice output unit is not mounted on the device equipped with the control unit, a display output means that substitutes for the voice output unit is proposed.

9. The proposal method according to claim 7, wherein
in the determination procedure, it is determined whether or not a moving mechanism as the mechanism for executing the scenario is mounted on the device equipped with the control unit, and
in the proposal procedure, in a case where the moving mechanism is not mounted on the device equipped with the control unit, an output means that substitutes for the moving mechanism is proposed.

10. The proposal method according to claim 9, wherein
in the proposal procedure, in a case where the moving mechanism is not mounted on the device equipped with the control unit, an output means capable of instructing a movement destination set by the scenario is proposed as an alternative plan.

11. The proposal method according to claim 1, wherein
in the proposal procedure, in a case where the proposed alternative means is approved, the scenario is updated based on the alternative means.

12. The proposal method according to claim 1, wherein
in the proposal procedure, an alternative means for executing the scenario is proposed based on a history of the alternative means having been executed in other devices in the past.

13. The proposal method according to claim 1, wherein
in the proposal procedure, in a case where there are a plurality of alternative means, the plurality of alternative means are proposed according to the order of priority set based on a history of the alternative means having been executed in the past.

14. A proposal device comprising:
a reception unit that receives a scenario for controlling behavior of a device, the scenario being commonly used among different devices;
a determination unit that determines whether or not a function or a mechanism mounted on a device equipped with the reception unit satisfies requirements for executing the received scenario; and
a proposal unit that proposes an alternative means for executing the scenario when it is determined that it is difficult to execute the scenario.

15. A proposal program causing a computer to function as a proposal device comprising:
a reception unit that receives a scenario for controlling behavior of a device, the scenario being commonly used among different devices;
a determination unit that determines whether or not a function or a mechanism mounted on a device equipped with the reception unit satisfies requirements for executing the received scenario; and
a proposal unit that proposes an alternative means for executing the scenario when it is determined that it is difficult to execute the scenario.
